(19) United States
(12) Patent Application Publication
(10) Pub. No.: US 2025/0200968 A1
(43) Pub. Date: Jun. 19, 2025

(54) SYSTEM CAPABLE OF DYNAMICALLY GENERATING AND EXECUTING WORKFLOW COMMANDS OVER 5G NETWORK

(71) Applicant: T-Mobile USA, Inc., Bellevue, WA (US)

(72) Inventor: Phi Nguyen, Lacey, WA (US)

(21) Appl. No.: 18/541,694

(22) Filed: Dec. 15, 2023

(51) Int. Cl. G06V 20/40; B60W 50/14; B60W 60/00; G06F 8/41; G06Q 30/0601; H04L 67/06

(52) U.S. Cl. CPC G06V 20/41; B60W 60/001; B60W 60/0021; B60W 60/0023; G06N 5/04; G06N 20/00; G06V 10/70; G06V 20/50; G06V 20/56; G06V 20/58; G06V 20/60; G06V 20/68; G06V 20/70

(57) ABSTRACT

A system connects a 5G telecommunications network to a smart device equipped with a camera. The smart device uses a discriminative model to create a textual description of the scene describing recognized objects and locally converts the textual description to textual data. The system receives the textual data from the smart device over the 5G network. After receiving the file, the system causes the smart device to delete the video. The system inputs the textual data into a remotely located large language model (LLM) and analyzes the textual data based on the textual description of the scene. The system generates a proposed workflow as an executable file based on the LLM's analysis, where the proposed workflow corresponds to commands for the smart device. The system transfers the executable file over the 5G network to the smart device and causes the smart device to execute the executable file.

### BACKGROUND

Computer vision tasks include methods for acquiring, processing, analyzing, and understanding digital images and extraction of high-dimensional data from the real world in order to produce numerical or symbolic information, e.g., in the form of decisions. Understanding in this context means the transformation of visual images (the input to the retina in the human analog) into descriptions of the world that make sense of thought processes and can elicit appropriate action. This image understanding can be seen as the disentangling of symbolic information from image data using models constructed with the aid of geometry, physics, statistics, and learning theory. Computer vision seeks to automate tasks that the human visual system can do. Computer vision is concerned with the automatic extraction, analysis, and understanding of useful information from a single image or a sequence of images.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates a machine learning and large language model system that can implement aspects of the present technology.

FIG. 3 is a block diagram that illustrates generating multiple proposed workflows in an executable file.

FIG. 4 is a flow chart that illustrates selecting from multiple proposed workflows to update and train the large language model.

FIG. 5 is a flow chart that illustrates receiving textual descriptions of a scene to generate and execute an executable file.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The system connects to an end-user smart device equipped with a camera and locally records images of the smart device's surrounding area. Using a discriminative model, features in the images, such as objects or people, are detected locally on the device, eliminating the need to send the full image over the 5G network. The discriminative model indexes the detected objects and categorizes the objects as either important features or unimportant features. For example, important features are those objects that modify a proposed workflow and the commands the system follows. The system maps the important features and textually describes each important feature locally on the smart device. For example, the textual descriptions of the important features can describe the physical characteristics of the detected object or the actions the detected object performed. The system transfers the text from the smart device over a 5G network to a remote large language model (LLM) system, which analyzes the text and generates the proposed workflow. The proposed workflow contains instructions for a user or smart device to follow.

The disclosed technology accomplishes this by connecting to an end-user smart device equipped with a camera, such as a smartphone, automobile, or smart home appliance. Once connected, the system begins locally recording images of the smart device's surrounding area with its camera. Important features in the images, such as objects or people, are detected locally on the device, thereby eliminating the need to send the full image over the 5G network. What is deemed an important feature is a determinant of the location and situation in which the smart device is placed. For example, suppose the smart device is an automobile. In that case, important features may be other automobiles, pedestrians, or any object in the path of the automobile. On the other hand, if the smart device is a smart home appliance, the important features may be pets, food items, unknown intruders, active fires, active leaks such as water or gas leaks, or potentially hazardous activities performed by children. Using a discriminative model, the important features are identified and converted locally on the smart device to textual data that contains a written indication of the important features. For example, textual data is information stored and written in a text format. A text format can be any format capable of electronically transferring text, such as a text file, the file transfer protocol (FTP), the hypertext transfer protocol (HTTP), or a short message service. In another example, the discriminative model is located at another node at the edge of a telecommunications network, such as a network access node. The original image can then be deleted from the smart device, leaving only the textual data.

With only the textual data remaining locally on the smart device, the system transfers the textual data from the smart device over a 5G network to a remotely located LLM. Using the 5G network allows the textual data to be instantly transferred to the remote LLM system, reducing any delays that could be caused by sending the entire recorded image. The remotely located LLM can analyze the important features described within the textual data and generate a proposed workflow. The proposed workflow contains instructions to be followed by the user or smart device. For example, the proposed workflow can contain driving instructions indicating that the automobile should take a new route or slow down. In another example, when the smart device is located inside of a home, the proposed workflow can contain instructions indicating the need to feed a pet or buy a certain food item or the proper actions to take when an intruder is present, a water or gas leak occurs, or the actions to take to prevent a child from performing a hazardous activity. The proposed workflow is transferred to the smart device over the 5G network, where the user or smart device can execute it.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

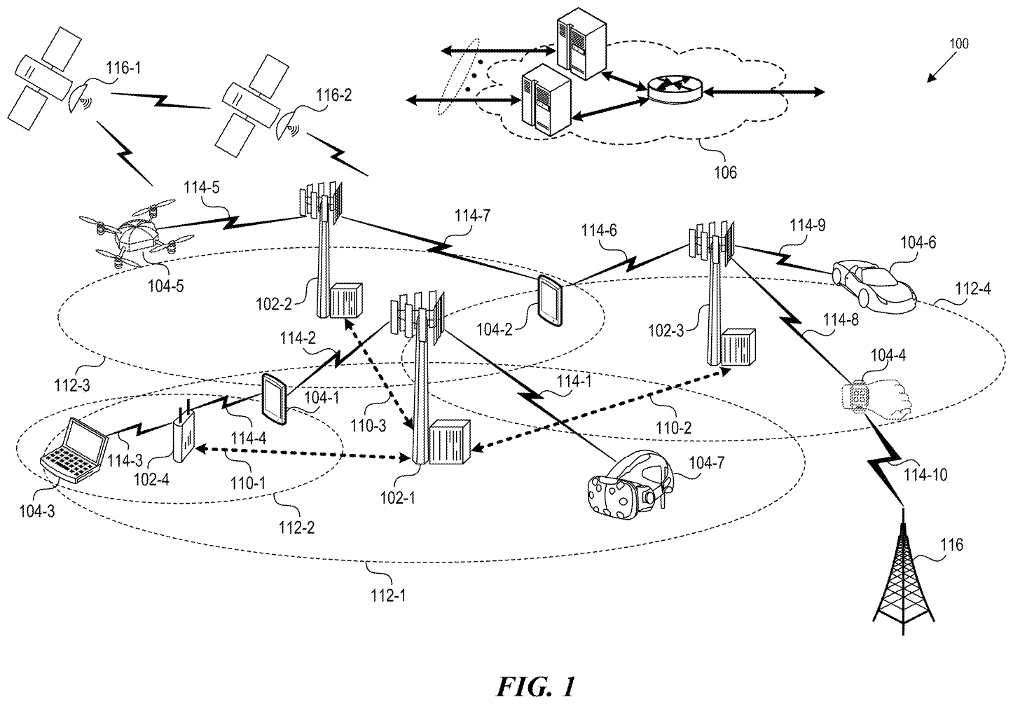

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publically-available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

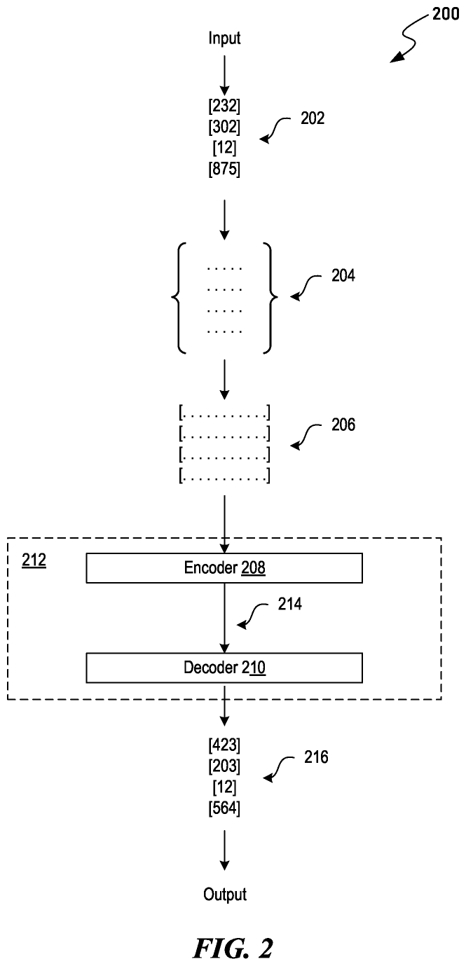

FIG. 2 is a block diagram of an example transformer 212. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 212 includes an encoder 208 (which can comprise one or more encoder layers/blocks connected in series) and a decoder 210 (which can comprise one or more decoder layers/blocks connected in series). Generally, the encoder 208 and the decoder 210 each include a plurality of neural network layers, at least one of which can be a self-attention layer. The parameters of the neural network layers can be referred to as the parameters of the language model.

The transformer 212 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 2 illustrates an example of how the transformer 212 can process textual input data. Input to a language model (whether transformer-based or otherwise) typically is in the form of natural language that can be parsed into tokens. It should be appreciated that the term “token” in the context of language models and Natural Language Processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for simplicity. In general, the token sequence that is inputted to the transformer 212 can be of any length up to a maximum length defined based on the dimensions of the transformer 212. Each token 202 in the token sequence is converted into an embedding vector 206 (also referred to simply as an embedding 206). An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some examples, the numerical value of the token 202 can be used to look up the corresponding embedding in an embedding matrix 204 (which can be learned during training of the transformer 212).

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as the latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 is able to generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some examples, the input provided to the transformer 212 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### System for Generating a Proposed Workflow Contained in an Executable File

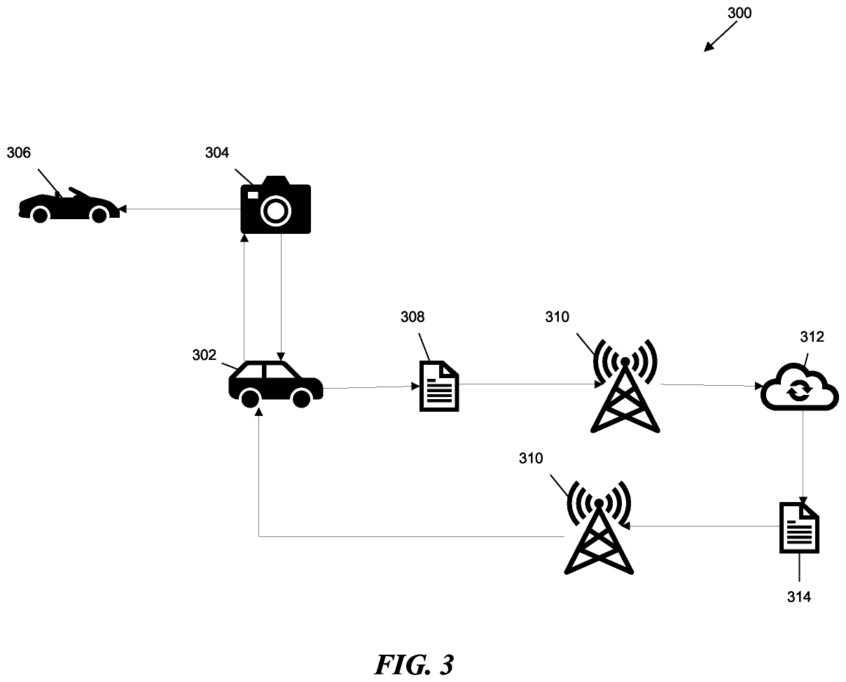

FIG. 3 is a block diagram that illustrates an example use case of the disclosed technology wherein the system 300 generates an executable file to execute driving commands for a smart vehicle 302. The smart vehicle 302 is operated by a user and capable of connecting to a 5G network. The smart vehicle 302 is equipped with a camera 304. The camera 304 is capable of capturing videos and/or pictures. In one example, a series of cameras are attached directly to the smart vehicle 302. The series of cameras can capture videos or images of the scene surrounding the smart vehicle 302 from the front, side, and back of the smart vehicle 302. In another example, the camera 304 is the user's smartphone. The user can attach the smartphone to the front of the smart vehicle 302 and is capable of capturing videos or images of the scene in front of the smart vehicle.

The camera 304 records videos or images of the scene surrounding the smart vehicle 302. The videos or images of the scene can contain objects such as a vehicle 306. The videos or images are transferred from the camera 304 to the smart vehicle 302. The smart vehicle 302 uses a discriminative model to create a textual description of the scene captured by the camera 304. The textual description describes the recognized objects, such as vehicle 306, in the vicinity of the smart vehicle 302. The smart vehicle 302 converts the textual description to a textual data 308. The textual data 308 for example, can be any format capable of storing text and being electronically transmitted. The smart vehicle 302 deletes the captured videos or images after the textual data 308 is created.

The smart vehicle 302 transmits the textual data 308 over a 5G network 310 to a remotely located large language model (LLM) 312. For example, the textual data 308 can be transmitted for example, via FTP or HTTP. The textual data 308 is inputted into the LLM 312. The LLM 312 analyzes the textual data 308 based on the textual description of the scene created by the discriminative model. The LLM 312 generates an executable file 314. The executable file 314 contains a proposed workflow corresponding to driving commands for the smart vehicle 302. The executable file 314 is transferred over the 5G network 310 to the smart vehicle 302. The smart vehicle 302 receives the executable file 314 and executes the executable file 314. In one example, the smart vehicle can be operated autonomously. The executable file 314 can cause the smart vehicle 302 to perform the driving commands found within the executable file 314. The driving commands can include causing the smart vehicle 302 to stop, make a turn, or change the route the smart vehicle 302 is following. In another example, the user is operating the smart vehicle 302. The smart vehicle 302 can notify the user of the driving commands in the executable file 314. The smart vehicle 302 can display the driving commands to the user, where the user can adjust the operation of the smart vehicle accordingly.

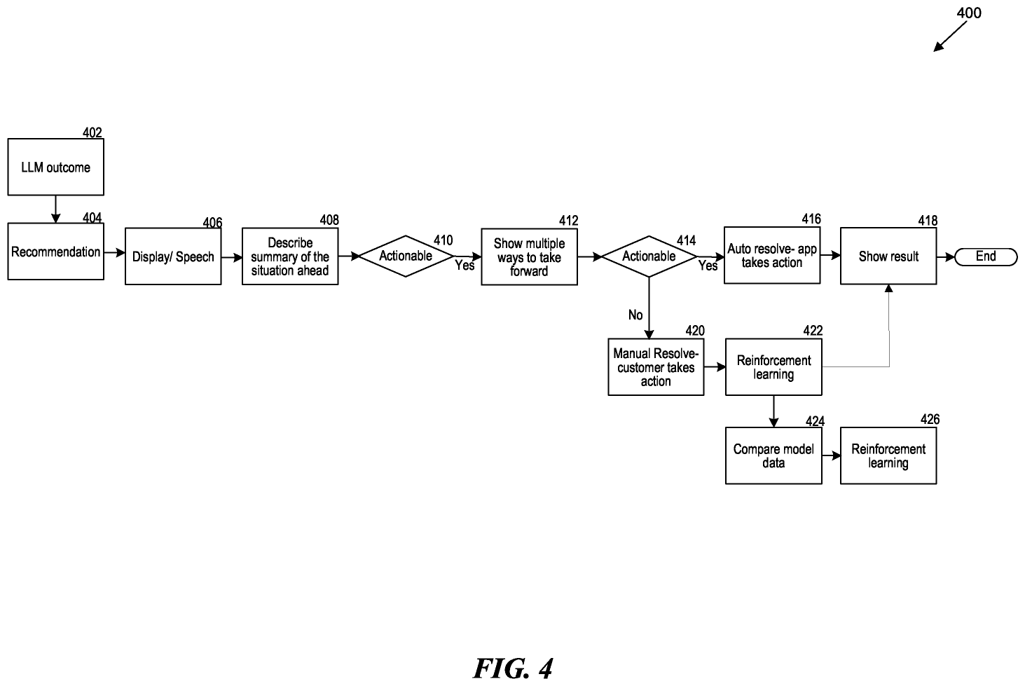

FIG. 4 is a flow chart that illustrates process 400 for generating multiple proposed workflows in an executable file and updating the LLM model based on the proposed workflow executed. At 402, the LLM can generate multiple proposed workflows. The multiple proposed workflows contain multiple sets of commands that can be executed by either the smart device or the user of the smart device. At 404, the multiple proposed workflows can be saved in an executable file and ranked to determine the recommended proposed workflow. The highest-ranked proposed workflows are the proposed workflows that the LLM believes to have the best outcome when the executable file is executed. At 406, the system can display a proposed set of commands. In one example, the system can use a text-to-speech functionality to speak the proposed set of commands to the user. At 408, the system can describe the summary of the situation ahead. The summary can describe why the proposed set of commands should be followed. In one example, the summary is displayed to the user like the proposed set of commands.

At 410, the system determines if the executable file can be executed. In one example, the determination to execute the executable file can be based on the existence of an actionable event. For example, if the smart device is a vehicle, the actionable event can be an upcoming turn or the need to apply the vehicle's brakes due to an impending obstruction. At 412, in response to an actionable event, the system can display multiple proposed sets of commands. At 414, the system can determine which of the proposed set of commands contained in the executable file should be executed. At 416, the system can determine that a proposed set of commands can be executed. In one example, the system determines which proposed set of commands to execute without any input from a user.

At 420, a user can manually determine which proposed set of commands should be followed. In one example, the user manually determines which proposed set of commands to follow based on an error from the system. The system's error can indicate that the system was unable to determine the proper proposed set of commands to follow. At 422, the system can perform reinforcement learning based on the user's manual determination of the proper proposed set of commands. At 424, the system can compare the result determined from the user-chosen set of commands to the model data. The model data can include data used to train the LLM and data used to determine the proper proposed set of commands to execute. At 426, the system can use the comparison of the user-chosen set of commands to the model data to perform reinforcement learning on the LLM.

At 418, the system can show the predicted result of executing the chosen set of commands found in the executable file. In one example, the system can execute the executable file without user input. In another example, the user executes the set of commands found within the executable file.

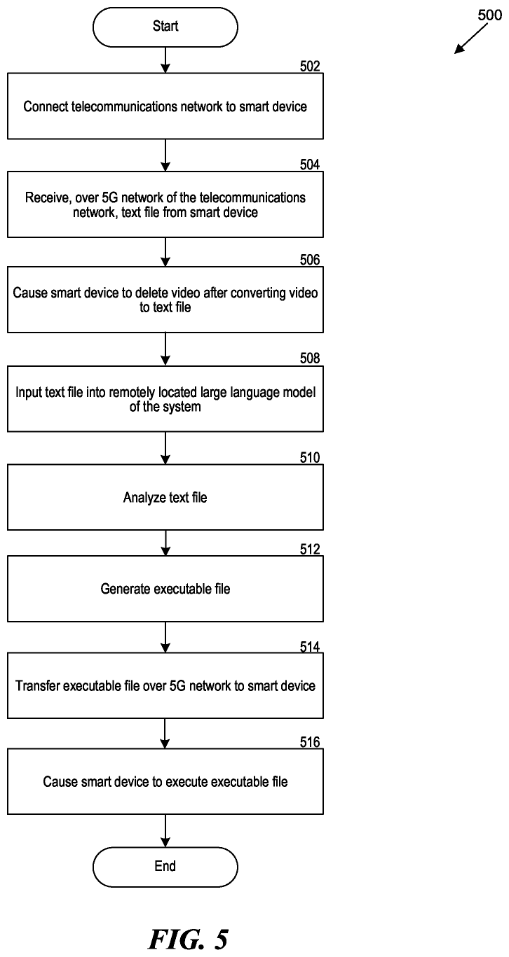

FIG. 5 is a flowchart that illustrates process 500 for receiving textual descriptions of a scene to generate and execute proposed workflows contained in an executable file. In one example, the system includes at least one hardware processor and at least one non-transitory memory storing instructions, which, when executed by the at least one hardware processor, cause the system to perform the process 500.

At 502, the system can connect a telecommunications network to a smart device. In one example, the smart device is equipped with a camera or device capable of capturing picture files or video files. In one example, the type of smart device includes a smartphone, a vehicle, a smart appliance, or a smart camera.

At 504, the system can receive, over a 5G network of the telecommunications network, a textual data from the smart device that includes data indicative of objects in a scene recognized in the vicinity of the smart device. In one example, the smart device locally captures a video of the scene using the camera and uses a discriminative model to create a textual description of the scene, which describes the recognized objects in the vicinity of the smart device. The smart device converts the textual description of the scene to the textual data locally on the smart device, thereby reducing the bandwidth utilization on the 5G network of the telecommunications network compared to transmitting the video file. In one example, the system can cause the smart device to locally detect an object captured in the video of the scene, where the smart device uses a discriminative model to index a detected object. The system can cause the smart device to categorize the detected object, where the detected object is categorized as either an important feature or an unimportant feature. The important feature modifies the commands contained in the executable file. The system can cause the smart device to map the important feature. The smart device maps the important feature based on an analysis of the detected object. The system can cause the smart device to generate a textual description of the important feature, where the textual description is based on the map of the important feature.

At 506, the system can cause the smart device to delete the video after converting the video to the textual data. At 508, the system can input the textual data into a remotely located large language model (LLM) of the system. In one example, the remotely located LLM is located at the edge of the 5G network, reducing an amount of time required to generate the executable file and transfer the executable file to the smart device. In one example, the remotely located LLM is trained using textual data converted from image data captured by subscribers of the telecommunications network or activity data of subscribers on the telecommunications network. At 510, the system can analyze the textual data based on the textual description of the scene using the remotely located LLM.

At 512, the system can generate an executable file based on the analysis performed by the remotely located LLM. In one example, the executable file contains a proposed workflow. The proposed workflow corresponds to commands for the smart device. The proposed workflow is unique to the smart device. In one example, the smart device is a vehicle, and the system can generate the proposed workflow, including a set of driving commands for the smart device to perform. The system can convert the proposed workflow to a driving command file and transfer the driving command file over the 5G network to the smart device. The system can cause the smart device to enact the driving commands in the driving command file. The system can generate a driving notification, where the driving notification indicates to a driver the driving action the smart device is configured to perform in response to the driving command file. The system can forward the driving notification over the 5G network to the smart device and can cause the smart device to notify the user of the received driving notification. In another example, the smart device is a vehicle, and the proposed workflow reduces greenhouse gas emissions by generating driver commands that instruct the vehicle to reduce driving time or distance traveled.

In one example, the system can analyze the executable file, where the executable file is analyzed for a product that assists in executing the commands contained in the executable file. The system can generate a list of proposed products determined from the analysis of the executable file, where the list of proposed products includes digital links to purchase a product. The system can transfer the list of proposed products over the 5G network to the smart device. In another example, the smart device is a smartphone, and the system can generate an updated executable file, where the updated executable file is generated when the smart device enters a new location. The system can transfer the updated executable file over the 5G network to the smart device. The system can generate an update notification, where the update notification indicates that the executable file has updated commands for the smart device to execute. The system can forward the update notification over the 5G network to the smart device.

In one example, the system can generate multiple executable files, where the multiple executable files are generated using the textual data received from the smart device. The system can rank the multiple executable files. The system ranks the multiple executable files based on a determined outcome. The determined outcome is based on the commands contained in the executable file. The system can transfer the multiple executable files over the 5G network to the smart device, where the smart device executes the executable file selected from the multiple executable files.

At 514, the system can transfer the executable file over the 5G network to the smart device. At 516, the system can cause the smart device to execute the executable file. In one example, the smart device performs the commands generated in the proposed workflow.

### Computer System

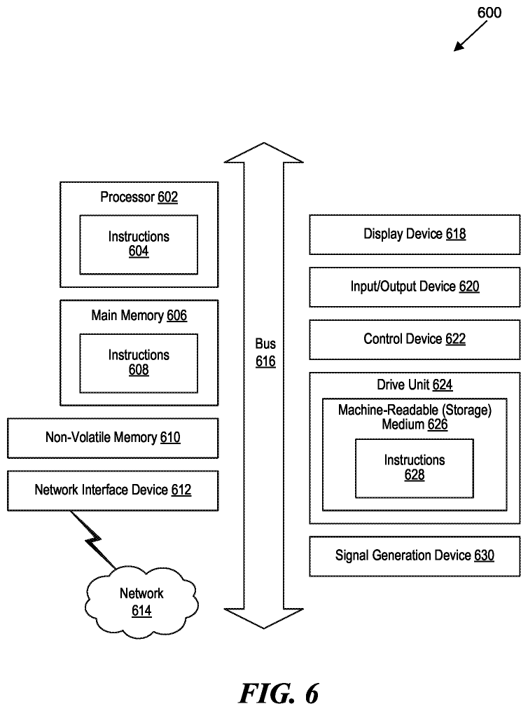

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense-that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A system comprising:
at least one hardware processor; and
at least one non-transitory memory storing instructions, which, when executed by the at least one hardware processor, cause the system to:
connect a telecommunications network to a smart device,
wherein the smart device is equipped with a camera;
receive, over a 5G network of the telecommunications network, textual data from the smart device that includes data indicative of objects in a scene recognized in a vicinity of the smart device,
wherein the smart device locally captures a video of the scene using the camera and uses a discriminative model to create a textual description of the scene, which describes the recognized objects in the vicinity of the smart device, and
wherein the smart device converts the textual description of the scene to the textual data locally on the smart device, thereby reducing bandwidth utilization on the 5G network of the telecommunications network compared to transmitting a video file;
cause the smart device to delete the video after converting the video to the textual data;
input the textual data into a remotely located large language model (LLM), located on of the telecommunications network, of the system,
wherein the remotely located LLM is trained using textual data converted from image data captured by subscribers of the telecommunications network and activity data of subscribers on the telecommunications network, and
wherein activity data of subscribers on the telecommunications network includes tracking data relating to interactions a subscriber has with the telecommunications network generated by a core network of the telecommunications network;
analyze the textual data based on the textual description of the scene using the remotely located LLM;
generate an executable file based on the analysis performed by the remotely located LLM,
wherein the executable file contains a proposed workflow,
wherein the proposed workflow corresponds to commands for the smart device,
wherein the proposed workflow is unique to the smart device, and
wherein the executable file contains a summary described by the LLM of a rationale for executing the proposed workflow;
transfer the executable file over the 5G network to the smart device;
cause the smart device to display the summary of the rationale for executing the proposed workflow;
receive a modification, from the smart device, to the proposed workflow based on an input from a user,
wherein the user modifies the proposed workflow based on the summary of the rationale for executing the proposed workflow; and
cause the smart device to execute the executable file,
wherein the smart device performs the modified commands in the modified proposed workflow.

2. The system of claim 1, wherein a type of smart device includes:
a smartphone;
a vehicle;
a smart appliance; or
a smart camera.

3. The system of claim 1, wherein the smart device is a vehicle, the instructions further cause the system to:
generate the proposed workflow, including a set of driving commands for the smart device to perform;
convert the proposed workflow to a driving command file;
transfer the driving command file over the 5G network to the smart device;
cause the smart device to enact the driving commands in the driving command file;
generate a driving notification,
wherein the driving notification indicates to a driver the driving command the smart device is configured to perform in response to the driving command file;
forward the driving notification over the 5G network to the smart device; and
cause the smart device to notify the driver of the driving notification.

4. The system of claim 1, wherein the smart device is a vehicle:
wherein the proposed workflow reduces greenhouse gas emissions by generating driver commands that instruct the vehicle to reduce driving time or distance traveled.

5. The system of claim 1:
wherein the remotely located LLM is located at an edge of the 5G network, reducing an amount of time required to generate the executable file and transfer the executable file to the smart device.

6. The system of claim 1, the instructions further cause the system to:
analyze the executable file,
wherein the executable file is analyzed for a product that assists in executing the commands contained in the executable file;
generate a list of proposed products determined from the analysis of the executable file,
wherein the list of proposed products includes digital links to purchase a product; and
transfer the list of proposed products over the 5G network to the smart device.

7. The system of claim 1, wherein the smart device is a smartphone, the instructions further cause the system to:
generate an updated executable file,
wherein the updated executable file is generated when the smart device enters a new location;
transfer the updated executable file over the 5G network to the smart device;
generate an update notification,
wherein the update notification indicates that the executable file has updated commands for the smart device to execute; and
forward the update notification over the 5G network to the smart device.

8. The system of claim 1, the instructions further cause the system to:
generate multiple executable files,
wherein the multiple executable files are generated using the textual data received from the smart device;
rank the multiple executable files,
wherein the system ranks the multiple executable files based on a determined outcome, and
wherein the determined outcome is based on the commands contained in the executable file; and
transfer the multiple executable files over the 5G network to the smart device,
wherein the smart device executes the executable file selected from the multiple executable files.

9. The system of claim 1, the instructions further cause the system to:
cause the smart device to locally detect an object captured in the video of the scene,
wherein the smart device uses the discriminative model to index a detected object;
cause the smart device to categorize the detected object,
wherein the detected object is categorized as either an important feature or an unimportant feature,
wherein the important feature modifies the commands contained in the executable file;
cause the smart device to map the important feature,
wherein the smart device maps the important feature based on an analysis of the detected object; and
cause the smart device to generate the textual description of the important feature,
wherein the textual description is based on the map of the important feature.

10. A non-transitory, computer-readable storage medium comprising instructions recorded thereon, wherein the instructions, when executed by at least one data processor of a system, cause the system to:
connect a telecommunications network to a smart device,
wherein the smart device is equipped with a camera;
receive, over a 5G network of the telecommunications network, textual data from the smart device that includes data indicative of objects in a scene recognized in a vicinity of the smart device,
wherein the smart device locally captures a video of the scene using the camera and uses a discriminative model to create a textual description of the scene, which describes the recognized objects in the vicinity of the smart device, and
wherein the smart device converts the textual description of the scene to the textual data locally on the smart device;
input the textual data into a remotely located large language model (LLM), located on the telecommunications network, of the system,
wherein the remotely located LLM is trained using activity data of subscribers on the telecommunications network, and
wherein activity data of subscribers on the telecommunications network includes tracking_data relating to interactions a subscriber has with the telecommunications network generated by a core network of the telecommunications network;
analyze the textual data based on the textual description of the scene using the remotely located LLM;
generate an executable file based on the analysis performed by the remotely located LLM,
wherein the executable file contains a proposed workflow, and
wherein the proposed workflow corresponds to commands for the smart device, and
wherein the executable file contains a summary described by the LLM of a rationale for executing the proposed workflow;
transfer the executable file over the 5G network to the smart device;
cause the smart device to display the summary of the rationale for executing the proposed workflow;
receive a modification, from the smart device, to the proposed workflow based on an input from a user,
wherein the user modifies the proposed workflow based on the summary of the rationale for executing the proposed workflow; and
cause the smart device to execute the executable file,
wherein the smart device performs the modified_commands generated in the modified proposed workflow.

11. The computer-readable storage medium of claim 10, wherein a type of smart device includes:
a smartphone;
a vehicle;
a smart appliance; or
a smart camera.

12. The computer-readable storage medium of claim 10, wherein the smart device is a vehicle, the instructions further cause the system to:
generate the proposed workflow, including a set of driving commands for the smart device to perform;
convert the proposed workflow to a driving command file;
transfer the driving command file over the 5G network to the smart device;
cause the smart device to enact the driving commands in the driving command file;
generate a driving notification,
wherein the driving notification indicates to a driver the driving command the smart device is configured to perform in response to the driving command file;
forward the driving notification over the 5G network to the smart device; and
cause the smart device to notify the driver of the driving notification.

13. The computer-readable storage medium of claim 10, wherein the smart device is a smartphone, the instructions further cause the system to:
generate an updated executable file,
wherein the updated executable file is generated when the smart device enters a new location;
transfer the updated executable file over the 5G network to the smart device;
generate an update notification,
wherein the update notification indicates that the executable file has updated commands for the smart device to execute; and
forward the update notification over the 5G network to the smart device.

14. The computer-readable storage medium of claim 10, the instructions further cause the system to:
cause the smart device to locally detect an object captured in the video of the scene,
wherein the smart device uses the discriminative model to index a detected object;
cause the smart device to categorize the detected object,
wherein the detected object is categorized as either an important feature or an unimportant feature,
wherein the important feature modifies the commands contained in the executable file;
cause the smart device to map the important feature,
wherein the smart device maps the important feature based on an analysis of the detected object; and
cause the smart device to generate the textual description of the important feature,
wherein the textual description is based on the map of the important feature.

15. A method comprising:
connecting a telecommunications network to a smart device,
wherein the smart device is equipped with a camera;
receiving, over a 5G network of the telecommunications network, textual data from the smart device,
wherein the smart device locally captures a video of a scene using the camera and uses a discriminative model to create a textual description of the scene, which describes recognized objects in a vicinity of the smart device, and
wherein the smart device converts the textual description of the scene to the textual data locally on the smart device;
inputting the textual data into a remotely located large language model (LLM), located on the telecommunications network,
wherein the remotely located LLM is trained using activity data of subscribers on the telecommunications network,
wherein activity data of subscribers on the telecommunications network includes tracking_data relating to interactions a subscriber has with the telecommunications network generated by a core network of the telecommunications network;
analyzing the textual data based on the textual description of the scene using the remotely located LLM;
generating an executable file based on the analysis performed by the remotely located LLM,
wherein the executable file contains a proposed workflow, and
wherein the proposed workflow corresponds to commands for the smart device, and
wherein the executable file contains a summary described by the LLM of a rationale for executing the proposed workflow;
transferring the executable file over the 5G network to the smart device; and
causing the smart device to display the summary of the rationale for executing the proposed workflow;
receiving a modification, from the smart device, to the proposed workflow based on an input from a user,
wherein the user modifies the proposed workflow based on the summary of the rationale for executing the proposed workflow; and
causing the smart device to execute the executable file,
wherein the smart device performs the modified_commands in the modified proposed workflow.

16. The method of claim 15, wherein a type of smart device includes:
a smartphone;
a vehicle;
a smart appliance; or
a smart camera.

17. The method of claim 15, wherein the smart device is a vehicle, the method further comprising:
generating the proposed workflow, including a set of driving commands for the smart device to perform;
converting the proposed workflow to a driving command file;
transferring the driving command file over the 5G network to the smart device;
causing the smart device to enact the driving commands in the driving command file;
generating a driving notification,
wherein the driving notification indicates to a driver the driving command the smart device is configured to perform in response to the driving command file;
forwarding the driving notification over the 5G network to the smart device; and
causing the smart device to notify the driver of the driving notification.

18. The method of claim 15, further comprising:
analyzing the executable file,
wherein the executable file is analyzed for a product that assists in executing the commands contained in the executable file;
generating a list of proposed products determined from the analysis of the executable file,
wherein the list of proposed products includes digital links to purchase a product; and
transferring the list of proposed products over the 5G network to the smart device.

19. The method of claim 15, wherein the smart device is a smartphone, the method further comprising:
generating an updated executable file,
wherein the updated executable file is generated when the smart device enters a new location;
transferring the updated executable file over the 5G network to the smart device;
generating an update notification,
wherein the update notification indicates that the executable file has updated commands for the smart device to execute; and
forwarding the update notification over the 5G network to the smart device.

20. The method of claim 15, further comprising:
causing the smart device to locally detect an object captured in the video of the scene,
wherein the smart device uses the discriminative model to index a detected object;
causing the smart device to categorize the detected object,
wherein the detected object is categorized as either an important feature or an unimportant feature,
wherein the important feature modifies the commands contained in the executable file;
causing the smart device to map the important feature,
wherein the smart device maps the important feature based on an analysis of the detected object; and
causing the smart device to generate the textual description of the important feature,
wherein the textual description is based on the map of the important feature.
